(19) United States
(12) Patent Application Publication
(10) Pub. No.: US 2026/0308370 A1
(43) Pub. Date: Oct. 8, 2026

(54) CURABLE COMPOSITION AND CURED PRODUCT

(71) Applicant: KANEKA CORPORATION, Osaka (JP)

(72) Inventors: Tetsuya Kogiso, Osaka (JP); Akira Kikuzawa, Osaka (JP)

(73) Assignee: KANEKA CORPORATION, Osaka (JP)

(21) Appl. No.: 19/680,318

(22) Filed: May 18, 2026

Related U.S. Application Data
(63) Continuation of application No. PCT/JP2024/038553, filed on Oct. 29, 2024.

(30) Foreign Application Priority Data
Nov. 21, 2023 (JP) 2023-197635

(51) Int. Cl. C08L 51/08; C08J 5/24

(52) U.S. Cl. CPC C08L 51/08; C08J 5/244; C08J 2351/08; C08J 2409/06; C08J 2425/12; C08J 2453/00; C08L 2205/035; C08L 2207/53

(57) ABSTRACT

A curable composition that provides a cured product having both a low dielectric loss tangent and excellent adhesion to a copper foil, a cured product of the curable composition, a metal-clad laminate provided with a metal layer and a substrate containing the cured product, and a method for producing the curable composition are provided. The curable composition contains a modifier (A), a modified polyphenylene ether (B), and a radically polymerizable compound (C). The modifier (A) includes core-shell polymer particles (A2) and a modified styrene-based elastomer (A1-1) as a modified resin (A1). A common polar group is included in the modified resin (A) and the core-shell polymer particles (A2). The modified polyphenylene ether (B) has a carbon-carbon unsaturated double bond-containing group that is bound to an oxygen atom at a terminal of the molecule chain.

### TECHNICAL FIELD

One or more embodiments of the present invention relate to a curable composition that gives a cured product having both excellent adhesion to a copper foil and a low dielectric loss tangent, a cured product of the curable composition, a metal-clad laminate including a substrate that includes the cured product and including a metal layer, and a method for producing the curable composition.

### BACKGROUND

In recent years, communication devices such as smartphones and electronic devices such as next-generation televisions have been required to transmit and receive large volumes of data at high speed. Accordingly, frequencies for electrical signals have become higher. Specifically, in the field of wireless communications, the use of high-frequency bands of 10 GHz or more is being considered for introduction of the fifth-generation mobile communication system.

However, as the frequency of the signal used increases, the transmission loss that can cause misrecognition of information increases. In order to reduce this transmission loss, there is a demand for low-dielectric materials with low relative dielectric constant and low dielectric loss tangent, which are factors related to the dielectric loss caused by insulating resins constituting electronic components such as a substrate. In such circumstances, for the purpose of obtaining a low-dielectric material that can be used in high-frequency bands, a technology has been proposed in which a styrene-based thermoplastic elastomer is added as a resin modifier to modified polyphenylene ether as a base resin in order to improve the dielectric property (see Patent Document 1).

### PATENT DOCUMENTS

Patent Document 1: Japanese Unexamined Patent Application Publication No. 2023-001134

Applications of materials with excellent low-dielectric property may include wiring boards. Wiring boards are usually copper-clad laminate (CCL). However, a wiring board including a film or sheet made of a resin composition as described in Patent Document 1, or a wiring board impregnated with a resin composition as described in Patent Document 1, does not necessarily have good adhesion to a copper foil.

### SUMMARY

One or more embodiments of the present invention have been made in view of the above, and aims to provide a curable composition that gives a cured product having both excellent adhesion to a copper foil and a low dielectric loss tangent, a cured product of the curable composition, a metal-clad laminate including a substrate that includes the cured product and including a metal layer, and a method for producing the curable composition.

The present inventors have intensively studied to address the above, and as a result, completed one or more embodiments of the present invention.

In other words, one or more embodiments of the present invention provide the following (1) to (15).

(1) A curable composition including a modifier (A), a modified polyphenylene ether (B), and a radically polymerizable compound (C),
the modifier (A) including a modified resin (A1) and core-shell polymer particles (A2),
the modified resin (A1) including a modified styrene-based elastomer (A1-1),
the modified resin (A1) and the core-shell polymer particles (A2) being modified with a monomer having one or more polar groups selected from the group consisting of an epoxy group, an amino group, an acid anhydride group, a hydroxy group, and a carboxy group,
a type of a group with a largest amount among the one or more polar groups of the modified resin (A1) being the same as a type of a group with a largest amount among the one or more polar groups of the core-shell polymer particles (A2),
the modified polyphenylene ether (B) including a carbon-carbon unsaturated double bond-containing group bonded to an oxygen atom at a molecular chain terminal, and
the radically polymerizable compound (C) including two or more radically polymerizable carbon-carbon unsaturated double bonds.
   (2) The curable composition according to (1), in which the modified polyphenylene ether (B) includes, as the carbon-carbon unsaturated double bond-containing group, one or more groups selected from a vinylbenzyl group, a vinyl group, an allyl group, and a (meth)acryloyl group.
   (3) The curable composition according to (1) or (2), in which the group with a largest amount among the one or more polar groups of the modified resin (A1), and the group with a largest amount among the one or more polar groups of the core-shell polymer particles (A2) are an epoxy group.
   (4) The curable composition according to any one of (1) to (3), including 25 parts by mass or more and 90 parts by mass or less of the modified resin (A1) and 10 parts by mass or more and 75 parts by mass or less of the core-shell polymer particles (A2) with respect to 100 parts by mass of the modifier (A).
   (5) The curable composition according to any one of (1) to (4), in which a content of the one or more polar groups in the modified resin (A1) is 0.1% by mass or more and 8% by mass or less with respect to a mass of the modified resin (A1).
   (6) The curable composition according to any one of (1) to (5), in which a content of the one or more polar groups in the core-shell polymer particles (A2) is 0.5% by mass or more and 10% by mass or less with respect to a mass of the core-shell polymer particles (A2).
   (7) The curable composition according to any one of (1) to (6), in which an amount of the radically polymerizable compound (C) is 10 parts by mass or more and 80 parts by mass or less with respect to 100 parts by mass of the modified polyphenylene ether (B).
   (8) The curable composition according to any one of (1) to (7), in which an amount of the core-shell polymer particles (A2) is 0.1 parts by mass or more and 30 parts by mass or less with respect to 100 parts by mass of the modified polyphenylene ether (B).
   (9) The curable composition according to any one of (1) to (8), in which an amount of the modified resin (A1) is 5 parts by mass or more and 50 parts by mass or less with respect to 100 parts by mass of the modified polyphenylene ether (B).
   (10) A cured product including the curable composition according to any one of (1) to (9).
   (11) The cured product according to (10), in which a dielectric loss tangent measured under condition of 40 GHz is less than 0.0050.
   (12) A metal-clad laminate including a substrate that includes the cured product according to (10) and including a metal layer.
   (13) The metal-clad laminate according to (12), in which a peel strength measured by peeling off the metal layer according to JIS C6471-1995 is 4.0 N/cm or more.
   (14) The metal-clad laminate according to (12) or (13), in which Rz on a main surface side of the metal layer is 0.3 μm or more and 2.0 μm or less in a state before the metal layer is laminated on the substrate.
   (15) A method for producing the curable composition according to any one of (1) to (9), the method including:
obtaining a first stock solution (a) including the modifier (A) and the modified polyphenylene ether (B);
obtaining a second stock solution (b) including the radically polymerizable compound (C); and
mixing the first stock solution (a) and the second stock solution (b).

### DETAILED DESCRIPTION

One or more embodiments of the present invention can provide a curable composition that gives a cured product having both excellent adhesion to a copper foil and a low dielectric loss tangent, a cured product of the curable composition, a metal-clad laminate including a substrate that includes the cured product and including a metal layer, and a method for producing the curable composition.

### <<Curable Composition>>

The curable composition includes a modifier (A), a modified polyphenylene ether (B), and a radically polymerizable compound (C).

The modifier (A) includes a modified resin (A1) and core-shell polymer particles (A2).

The modified resin (A1) includes a modified styrene-based elastomer (A1-1).

The modified resin (A1) and the core-shell polymer particles (A2) are modified with a monomer having one or more polar groups selected from the group consisting of an epoxy group, an amino group, an acid anhydride group, a hydroxy group, and a carboxy group.

A type of a group with a largest amount among the one or more polar groups of the modified resin (A1) is the same as a type of a group with a largest amount among the one or more polar groups of the core-shell polymer particles (A2).

The modified polyphenylene ether (B) includes a carbon-carbon unsaturated double bond-containing group bonded to an oxygen atom at a molecular chain terminal.

The radically polymerizable compound (C) includes two or more radically polymerizable carbon-carbon unsaturated double bonds.

The above curable composition gives a cured product having both excellent adhesion to a copper foil and a low dielectric loss tangent. Furthermore, the cured composition gives a cured product having excellent heat resistance.

The form of the curable composition is not particularly limited. The curable composition may be a varnish-like composition including the modified resin (A1), the modified polyphenylene ether (B), and the radically polymerizable compound (C) dissolved in an organic solvent, and the core-shell polymer particles (A2) dispersed in the organic solvent.

An organic solvent that can be included in the curable composition is the same as the organic solvent that may be included in the modifier (A). The organic solvent that may be included in the modifier (A) will be described later.

When the curable composition is a varnish-like composition including an organic solvent, the solid concentration of the curable composition may be 20% by mass or more and 80% by mass or less, or 30% by mass or more and 70% by mass or less.

Hereinafter, the essential and optional components included in the curable composition are described.

### <Modifier (A)>

The curable composition includes a modifier (A). The modifier includes a modified resin (A1) and core-shell polymer particles (A2). The modified resin (A1) includes a modified styrene-based elastomer (A1-1).

The modified resin (A1) and the core-shell polymer particles (A2) are modified with a monomer having one or more polar groups selected from the group consisting of an epoxy group, an amino group, an acid anhydride group, a hydroxy group, and a carboxy group.

A type of the group with a largest amount among the one or more polar groups of the modified resin (A1) is the same as a type of the group with a largest amount among the one or more polar groups of the core-shell polymer particles (A2).

The modifier (A) is blended with the modified polyphenylene ether (B) described below. When the modifier (A) is blended with the modified polyphenylene ether (B), the adhesion of the cured product of the curable composition including the modified polyphenylene ether (B) to a copper foil can be improved without significantly deteriorating the dielectric property of the modified polyphenylene ether (B).

The modifier (A) may include 25 parts by mass or more and 90 parts by mass or less of the modified resin (A1) and 10 parts by mass or more and 75 parts by mass or less of the core-shell polymer particles (A2) with respect to 100 parts by mass of the modifier (A).

The lower limit of the content of the modified resin (A1) in the modifier (A) may be 30 parts by mass or more, 40 parts by mass or more, or 50 parts by mass or more, with respect to 100 parts by mass of the modifier (A). Furthermore, the upper limit of the content of the modified resin (A1) may be 80 parts by mass or less, 70 parts by mass or less, or 60 parts by mass or less, with respect to 100 parts by mass of the modifier (A).

Therefore, the content of the modified resin (A1) in the modifier (A) may be 30 parts by mass or more and 80 parts by mass or less, 40 parts by mass or more and 70 parts by mass or less, or 50 parts by mass or more and 60 parts by mass or less, with respect to 100 parts by mass of the modifier (A).

The lower limit of the content of the core-shell polymer particles (A2) in the modifier (A) may be 20 parts by mass or more, 30 parts by mass or more, and 40 parts by mass or more, with respect to 100 parts by mass of the modifier (A). The upper limit of the content of the core-shell polymer particles (A2) may be 70 parts by mass or less, 60 parts by mass or less, and 50 parts by mass or less, with respect to 100 parts by mass of the modifier (A).

Therefore, the content of the core-shell polymer particles (A2) in the modifier (A) may be 20 parts by mass or more and 70 parts by mass or less, 30 parts by mass or more and 60 parts by mass or less, and 40 parts by mass or more and 50 parts by mass or less, with respect to 100 parts by mass of the modifier (A).

The amount of the modified resin (A1) derived from the modifier (A) in the curable composition may be 5 parts by mass or more and 50 parts by mass or less, 7 parts by mass or more and 40 parts by mass or less, or 10 parts by mass or more and 30 parts by mass or less, with respect to 100 parts by mass of the modified polyphenylene ether (B).

The amount of the core-shell polymer particles (A2) derived from the modifier (A) in the curable composition may be 0.1 parts by mass or more and 30 parts by mass or less, 0.5 parts by mass or more and 25 parts by mass or less, or 1 part by mass or more and 18 parts by mass or less, with respect to 100 parts by mass of the modified polyphenylene ether (B).

The essential and optional components included in the modifier (A) are described below.

### [Modified Resin (A1)]

The modified resin (A1) is resin modified with a monomer having one or more polar groups selected from the group consisting of an epoxy group, an amino group, an acid anhydride group, a hydroxy group, and a carboxy group.

The constituent unit derived from a monomer having a polar group may be bonded to the main chain of the resin as a side chain of the resin by graft polymerization, or may be bonded to the main chain of the resin as a constituent unit constituting the main chain of the resin.

The content of the polar group in the modified resin (A1) is not particularly limited as long as the desired effect is not impaired. The content of the polar group in the modified resin (A1) may be 0.1% by mass or more and 8% by mass or less, 0.1% by mass or more and 5% by mass or less, or 0.1% by mass or more and 3% by mass or less, with respect to the mass of the modified resin (A1).

The content of the polar group in the modified resin (A1) can be measured by various methods according to the type of the polar group. When the polar group is an epoxy group, for example, the content of the epoxy group in the modified resin (A1) can be measured using a potentiometric titration device in accordance with JIS K7236.

The ratio of the mass of the polar group with a largest amount to the total amount of the mass of polar groups of the modified resin (A1) may be 50% by mass or more and 100% by mass or less, 75% by mass or more and 100% by mass or less, 90% by mass or more and 100% by mass or less, or 100% by mass.

The ratio of the mass of the polar group with a largest amount to the total mass of the polar groups of the core-shell polymer particles (A2) may be 50% by mass or more and 100% by mass or less, 75% by mass or more and 100% by mass or less, 90% by mass or more and 100% by mass or less, or 100% by mass.

The modified resin (A1) includes a modified styrene-based elastomer (A1-1).

The modified resin (A1) may include a modified resin other than the modified styrene-based elastomer (A1-1) as long as the desired effects are not impaired.

Examples of the modified resins other than the modified styrene-based elastomer (A1-1) include modified polyolefin-based resin, modified (meth)acrylic resin, modified polystyrene resin, modified polyphenylene ether resin not corresponding to the modified polyphenylene ether (B), modified silicone resin, modified polyester resin, modified fluororesin, and the like.

Among these, modified polyolefin resin is preferable.

These modified resins other than the modified styrene-based elastomer (A1-1) can be obtained by using a monomer having the above-mentioned specific polar group when the modified resin is produced, or by allowing a monomer having the above-mentioned specific polar group to be reacted with the main chain of the resin to introduce a branch having a polar group into the main chain.

The content of the modified styrene-based elastomer (A1-1) may be 70% by mass or more and 100% by mass or less, 80% by mass or more and 100% by mass or less, 90% by mass or more and 100% by mass or less, or 100% by mass, with respect to the mass of the modified resin (A1).

### [Modified Styrene-Based Elastomer (A1-1)]

The styrene-based elastomer is a block copolymer including a polystyrene-based block derived from a styrene-based monomer consisting of styrene and a styrene derivative.

The modified styrene-based elastomer (A1-1) is a modified resin obtained by modifying the above-mentioned styrene-based elastomer with a monomer having one or more polar groups selected from the group consisting of an epoxy group, an amino group, an acid anhydride group, a hydroxy group, and a carboxy group.

The styrene monomer used as the raw material of the styrene-based elastomer is not particularly limited. Suitable examples of the styrene monomer include styrene, 4-methylstyrene, α-methylstyrene, 2,4-dimethylstyrene, α-methyl-4-methylstyrene, 4-chlorostyrene, α-chloro-4-chlorostyrene, 4-tert-butylstyrene, 4-methoxystyrene, 4-chloromethylstyrene, styrene derivatives substituted with a silyl group, and the like.

Among the above-mentioned styrene-based monomers, styrene, α-methylstyrene, and 4-methylstyrene are preferable, and from the viewpoint of cost, styrene and α-methylstyrene are more preferable.

Blocks other than the polystyrene-based block in the styrene-based elastomer may be any of various known blocks applied to styrene-based elastomers.

As the styrene-based elastomer, styrene/isoprene/styrene elastomer, styrene/isobutylene/styrene elastomer, styrene/ethylenebutylene/styrene elastomer, hydrogenated styrene/isoprene/styrene elastomer, and hydrogenated styrene/(butadiene/isoprene)/styrene elastomer are preferable.

The polystyrene-based block in the styrene-based elastomer may be a block made of polystyrene, a block made of a homopolymer of a styrene derivative, or a block made of a copolymer of two or more kinds of styrene monomers. The polystyrene block in the styrene-based elastomer may be a block made of polystyrene.

Among the polar groups included in the monomer used for modification, an epoxy group is preferable because it has an excellent effect of improving the adhesion of the cured product of the curable composition to a copper foil.

The monomer having a polar group may have two or more polar groups. As the monomer having a polar group, a compound having one or two polar groups is preferable, and a compound having one polar group is more preferable.

Examples of the monomer having a polar group include unsaturated group-containing epoxy compounds such as glycidyl (meth)acrylate, monoglycidyl maleate, monoglycidyl itaconate, monoglycidyl allyl succinate, allyl glycidyl ether, 3,4-epoxy-1-butene, and vinylcyclohexene monoxide; unsaturated amines such as allylamine, methallylamine, 1-amino-4-pentene, and 4-vinylaniline; unsaturated group-containing acid anhydrides such as maleic anhydride; hydroxyl group-containing unsaturated compounds such as 2-hydroxyethyl (meth)acrylate, allyl alcohol, methallyl alcohol, 1-butenyl alcohol, and 4-hydroxystyrene; and unsaturated carboxylic acids such as (meth)acrylic acid, maleic acid, fumaric acid, itaconic acid, and crotonic acid. Among these, glycidyl (meth)acrylate is preferable because of its excellent adhesion improving effect.

When the modified styrene-based elastomer (A1) is produced, the monomer having a polar group may be used in combination of two or more kinds.

The modification with a monomer having a polar group may be a graft modification, or a modification of incorporating a monomer having a polar group into a block constituting the styrene-based elastomer by copolymerization.

The graft-modification modified styrene-based elastomer (A1-1) may be graft-modified with a monomer having a polar group and an aromatic vinyl monomer not having a polar group.

By using the monomer having a polar group and the aromatic vinyl monomer not having a polar group in combination, the graft reaction is stabilized, thus making it easier to graft a desired amount of vinyl monomer having a polar group.

Specific examples of the aromatic vinyl monomers not having a polar group include styrene, 4-methylstyrene, α-methylstyrene, 4-chlorostyrene, α-chlorostyrene, dichlorostyrene, 4-nitrostyrene, and the like. Among these, styrene, α-methylstyrene, or 4-methylstyrene is preferable because of being inexpensive, and styrene is particularly preferable. Aromatic vinyl monomers that do not have a polar group can be used alone or in combination of two or more types.

Examples of radical polymerization initiators that can be used when graft-modifying the styrene-based elastomer include 2,2-bis(tert-butylperoxy)butane, α,α′-bis(tert-butylperoxy-m-isopropyl)benzene, benzoyl peroxide, di(3-methyl-3-methoxybutyl)peroxydicarbonate, di-tert-butylperoxyisophthalate, and the like. The above radical polymerization initiators can be used alone or in combination of two or more.

The amount of the radical polymerization initiator used is not particularly limited as long as the graft modification reaction proceeds well. The amount of the radical polymerization initiator used may be 0.01 parts by mass or more and 10 parts by mass or less, or 0.2 parts by mass or more and 5 parts by mass or less, with respect to 100 parts by mass of the styrene-based elastomer.

The amount of the monomer having a polar group used for graft modification of the styrene-based elastomer may be 0.1 parts by mass or more and 12 parts by mass or less, 0.5 parts by mass or more and 10 parts by mass or less, or 1 part by mass or more and 8 parts by mass or less, with respect to 100 parts by mass of the styrene-based elastomer.

By using the modified styrene-based elastomer (A1-1) modified with the monomer having a polar group in an amount within this range, an excellent effect of improving the adhesion of the cured product of the curable composition to a copper foil can be achieved.

The amount of the aromatic vinyl monomer not having a polar group used for the graft modification of the styrene-based elastomer may be 0.1 parts by mass or more and 12 parts by mass or less, 0.5 parts by mass or more and 10 parts by mass or less, or 1 part by mass or more and 8 parts by mass or less, with respect to 100 parts by mass of the styrene-based elastomer.

When the modified styrene-based elastomer (A1-1) includes a constituent unit derived from a monomer having a polar group in the main chain, the modified styrene-based elastomer (A1-1) is obtained by copolymerizing a monomer that gives a block constituting the styrene-based elastomer with a monomer having a polar group according to a well-known method.

In this case, the styrene-based elastomer may be the same as that in the case of producing the modified styrene-based elastomer (A1-1) by graft modification.

### <Core-Shell Polymer Particles (A2)>

The core-shell polymer particles (A2) have a core-shell structure and are polymer particles modified with a monomer having one or more polar groups selected from the group consisting of an epoxy group, an amino group, an acid anhydride group, a hydroxy group, and a carboxy group.

The monomer having a polar group is as described above for the modified resin (A1).

Each of the core and shell may include two or more layers. In the case of a multi-layer structure, the polymer composition of each layer may be different. The shell is a layer formed by graft polymerizing a graft copolymerizable monomer (shell-forming monomer) to the core, and at least a part of the shell is present on the outermost side of the core-shell polymer particle (A2). The entire shell may not be on the outermost side of the core-shell polymer particle (A2).

In the core-shell polymer particles (A2), the outermost layer of the shell layer is usually modified with the monomer having a polar group.

The content of the polar group in the core-shell polymer particles (A2) is not particularly limited as long as the desired effect is not impaired. The content of the polar group in the core-shell polymer particles (A2) may be 0.5% by mass or more and 10% by mass or less, 0.7% by mass or more and 8% by mass or less, or 1% by mass or more and 6% by mass or less, with respect to the mass of the core-shell polymer particles (A2).

The content of the polar group in the core-shell polymer particles (A2) can be measured by various methods according to the type of the polar group. When the polar group is an epoxy group, for example, the content of the epoxy group in the core-shell polymer particles (A2) can be measured using a potentiometric titration device in accordance with JIS K7236.

The ratio of the mass of the core to the mass of the shell in the core-shell polymer particles, may be 50/50 to 99/1, 60/40 to 95/5, or 70/30 to 90/10 in terms of core/shell.

The core may be made of a cross-linked polymer. The cross-linked polymer is substantially insoluble in the solvent. The gel content in the core may be 60% by mass or more, 80% by mass or more, 90% by mass or more, or 95% by mass or more.

The core may be a rubber elastic body that is a polymer of monomers including 50% by mass or more and 100% by mass or less of one or more monomers selected from the group consisting of diene monomers and (meth)acrylic acid ester monomers and 0% by mass or more and 50% by mass or less of the other copolymerizable vinyl monomer, a rubber elastic body that is a polymer of monomers including 60% by mass or more and 100% by mass or less of monomers selected from the group consisting of diene monomers and (meth)acrylic acid ester monomers and 0% by mass or more and 40% by mass or less of the other copolymerizable vinyl monomer, or a rubber elastic body that is a polymer of monomers including 70% by mass or more and 100% by mass or less of one or more monomers selected from the group consisting of diene monomers and (meth)acrylic acid ester monomers and 0% by mass or more and 30% by mass or less of the other copolymerizable vinyl monomer.

Hereinafter, “a monomer selected from the group consisting of diene monomers and (meth)acrylic acid ester monomers” will be referred to as “monomer A”. The other copolymerizable vinyl monomer is a vinyl monomer copolymerizable with the monomer A. Furthermore, “(meth)acrylic” refers to both acrylic and methacrylic.

Examples of the diene monomer may include butadiene, isoprene, chloroprene, and the like, or butadiene.

Examples of the (meth)acrylic acid ester monomers may include butyl acrylate, 2-ethylhexyl acrylate, lauryl methacrylate, and the like, or butyl acrylate and 2-ethylhexyl acrylate. These monomers may be used alone or in combination of two or more kinds.

Examples of the vinyl monomer copolymerizable with the monomer A include one or more monomers selected from the group consisting of aromatic vinyl compounds, vinyl cyanide compounds, unsaturated carboxylic acid derivatives, (meth)acrylamide derivatives, and maleimide derivatives.

Examples of the aromatic vinyl compounds include styrene, α-methylstyrene, vinylnaphthalene, and the like. Examples of the vinyl cyanide compounds include (meth)acrylonitrile, substituted acrylonitrile, and the like. Examples of the unsaturated carboxylic acid derivatives include (meth)acrylic acid, itaconic acid, crotonic acid, maleic anhydride, and the like. Examples of the (meth)acrylamide derivatives include (meth)acrylamide, N-substituted (meth)acrylamide, and the like. Examples of the maleimide derivatives include maleimide, N-substituted maleimide, and the like. These monomers may be used alone or in combination of two or more.

When the polymer constituting the core is prepared, a crosslinkable monomer may be used for the purpose of suppressing swelling of the core due to a solvent.

Examples of the crosslinkable monomer include divinylbenzene, butanediol di(meth)acrylate, triallyl (iso)cyanurate, allyl (meth)acrylate, diallyl itaconate, diallyl phthalate, and the like. The amount of the crosslinkable monomer used may be 0.2% by mass or more and 7% by mass or less, 0.5% by mass or more and 5% by mass or less, or 1% by mass or more and 3% by mass or less, with respect to the mass of the core-shell polymer particles (A2).

Furthermore, coating the core with a crosslinkable monomer and forming an intermediate layer between the core and the shell are effective in suppressing fusion between the core-shell polymer particles (A2). A crosslinkable monomer used for forming the intermediate layer is not particularly limited, but may be trialkenyl isocyanurate compounds such as triallyl isocyanurate (TAIC).

In order to adjust the molecular weight and/or the degree of crosslinking of the polymer constituting the core layer, a chain transfer agent may be used in the polymerization of the core. Examples of the chain transfer agent include alkyl mercaptans having 5 or more and 20 or less carbon atoms. The amount of the chain transfer agent used may be 5% by mass or less, or 3% by mass or less, with respect to the mass of the core.

The core may include an aromatic vinyl crosslinked body. Examples of the aromatic vinyl crosslinked body include a copolymer of the aromatic vinyl compound and the above-described crosslinkable monomer.

Examples of aromatic vinyl compounds include styrene, 2-vinylnaphthalene, α-methylstyrene, 4-methylstyrene, 2,4-dimethylstyrene, 3,5-dimethylstyrene, 2,4,6-trimethylstyrene, 4-methoxystyrene, 2-chlorostyrene, and the like.

The type of the polymer constituting the shell is not particularly limited. The polymer constituting the shell may be a polymer of one or more monomers selected from a (meth)acrylic acid ester monomer, an aromatic vinyl monomer, a vinyl cyanide monomer, unsaturated carboxylic acid derivatives, (meth)acrylamide derivatives, and maleimide derivatives.

As the (meth)acrylic acid ester monomer, aromatic vinyl monomer, vinyl cyanide monomer, unsaturated carboxylic acid derivative, (meth)acrylamide derivative, and maleimide derivative, the above-mentioned compounds as specific examples of the monomer A and the vinyl monomer copolymerizable with the monomer A can be used.

The mass of styrene units may be 30% by mass or more, 40% by mass or more, or 50% by mass or more with respect to the mass of the core-shell polymer particles (A2).

Note here that the core-shell polymer particles (A2) are modified with a monomer having one or more polar groups selected from the group consisting of an epoxy group, an amino group, an acid anhydride group, a hydroxy group, and a carboxy group.

Therefore, in the core-shell polymer particles (A2), the resin constituting the shell may include a constituent unit derived from the monomer having the polar group described above, or that the monomer having the polar group described above is graft polymerized to the resin constituting the shell.

In modification of the core-shell polymer particles, a monomer having a polar group is used so that a ratio of the mass of the polar group to the mass of the core-shell polymer particles (A2) may fall within the range described above.

The volume average particle diameter of the core-shell polymer particles (A2) may be 10 nm or more and 400 nm or less, 50 nm or more and 300 nm or less, or 80 nm or more and 250 nm or less.

The volume average particle diameter of the core-shell polymer particles (A2) can be measured by using, for example, a laser diffraction/scattering type particle size distribution analyzer such as Microtrac (Microtrac UPA, manufactured by Nikkiso Co., Ltd.).

The method for producing the core-shell polymer particles (A2) is not particularly limited. For example, well-known methods including emulsion polymerization, suspension polymerization, microsuspension polymerization, and the like, can be carried out. Especially, multistage emulsion polymerization is preferable.

### <Other Ingredients>

The modifier (A) may include other components in addition to the modified resin (A1) and the core-shell polymer particles (A2) depending on the application of the curable composition.

The other components include various additives such as compatibilizers, fillers, antioxidants, heat stabilizers, light stabilizers, flame retardants, lubricants, antistatic agents, colorants, rust inhibitors, crosslinking agents, foaming agents, fluorescent agents, surface smoothing agents, surface gloss improvers, and release improvers.

Furthermore, the modifier (A) may include an organic solvent, if necessary.

Examples of the organic solvent may include ketones such as methyl ethyl ketone and methyl isobutyl ketone; aliphatic hydrocarbons such as pentane, hexane, cyclohexane, octane, and decane; aromatic hydrocarbons such as benzene, toluene, and xylene; ethers such as diethyl ether, diisopropyl ether, and tetrahydrofuran; halogenated hydrocarbons such as methylene chloride, methyl chloroform, carbon tetrachloride, dichlorodifluoromethane, and perchloroethylene, and the like. These organic solvents may be used in combination of two or more kinds.

When the modifier (A) includes an organic solvent, the solid concentration of the modifier (A) is not particularly limited. The solid concentration of the modifier (A) may be 5% by mass or more and 50% by mass or less, or 10% by mass or more and 40% by mass or less.

The above-described modified resin (A1) and the core-shell polymer particles (A2) are uniformly mixed together with other additives, if necessary, to obtain the modifier (A). The modifier (A) may be prepared by mixing an organic solvent solution of the modified resin (A1) with a dispersion liquid in which the core-shell polymer particles (A2) are dispersed in an organic solvent.

### [Modified Polyphenylene Ether (B)]

The curable composition includes a modified polyphenylene ether (B). The modified polyphenylene ether (B) has a carbon-carbon unsaturated double bond-containing group bonded to an oxygen atom at a molecular chain terminal. Polyphenylene ether usually has a hydroxyl group bonded to an aromatic ring at a molecular chain terminal. The modified polyphenylene ether (B) is obtained by substituting the hydrogen atom in the hydroxyl group at the terminal with the carbon-carbon unsaturated double bond-containing group.

The carbon-carbon unsaturated double bond-containing group may be one or more groups selected from a vinylbenzyl group, a vinyl group, an allyl group, and a (meth)acryloyl group.

When the carbon-carbon unsaturated double bond-containing group is a vinylbenzyl group, an allyl group, or a (meth)acryloyl group, a terminal hydroxyl group of the polyphenylene ether can be converted to a vinylbenzyloxy group, an allyloxy group, or a (meth)acryloyloxy group in a conventional manner using a corresponding halide.

When the carbon-carbon unsaturated double bond-containing group is a vinyl group, the terminal hydroxyl group of polyphenylene ether can be converted to a vinyloxy group by a method such as an ether exchange reaction between a vinyl ether compound of an alkyl vinyl ether such as methyl vinyl ether and a terminal hydroxyl group; a vinylation reaction using a vinyl ester compound such as vinyl acetate; or addition of acetylene to the terminal hydroxyl group.

Furthermore, as the modified polyphenylene ether (B), commercially available products can be used. Specific examples of the commercially available products include vinylbenzyl-terminated polyphenylene ether such as OPE-2St-2200 and OPE-2st-1200 (both manufactured by Mitsubishi Gas Chemical Company, Inc.); and methacryloyl-terminated polyphenylene ethers such as Noryl (registered trademark) SA9000 (manufactured by SABIC Corporation).

The molecular weight of the modified polyphenylene ether (B) is not particularly limited as long as the desired effect is not impaired. The molecular weight of the modified polyphenylene ether (B) may be 1000 or more, or 2000 or more, in terms of number average molecular weight (Mn).

The molecular weight of the modified polyphenylene ether (B) may be 1000 or more and 10000 or less, or 2000 or more and 5000 or less, in terms of number average molecular weight (Mn).

### [Radically Polymerizable Compound (C)]

The curable composition includes a radically polymerizable compound (C). The radically polymerizable compound (C) is a compound including two or more radically polymerizable carbon-carbon unsaturated double bonds. Note here that the radically polymerizable compound (C) is a compound not corresponding to the category of the modified polyphenylene ether (B).

The molecular weight of the radically polymerizable compound (C) is not particularly limited. When the radically polymerizable compound (C) is not a polymer, the molecular weight of the radically polymerizable compound (C) may be 10000 or less.

The radically polymerizable compound (C) has a radically polymerizable group including a carbon-carbon unsaturated double bond. The radically polymerizable group is not particularly limited, but is typically a carbon-carbon double bond-containing group. Suitable examples of the carbon-carbon double bond-containing group include alkenyl groups such as a vinyl group, an allyl group, and a methallyl groups; an unsaturated acyl group such as a (meth)acryloyl group (an acryloyl group or a methacryloyl group); a maleimide group, and the like.

Suitable specific examples of the radically polymerizable compound (C) include divinylbenzene, triallyl cyanurate, triallyl isocyanurate, trimethallyl isocyanurate, trimethylolpropane tri(meth)acrylate, 1,3,5-triacryloylhexahydro-1,3,5-triazine, triallyl trimellitate, 1,3-phenylenediamine bismaleimide, dipropargyl terephthalate, diallyl phthalate, N,N′,N″,N″-tetraallyl terephthalamide, and the like.

Among these, one or more selected from the group consisting of divinylbenzene, triallyl cyanurate, triallyl isocyanurate, trimethallyl isocyanurate, and trimethylolpropane tri(meth)acrylate are more preferable.

Furthermore, a bismaleimide compound obtained by allowing a terminal amino group of an oligomer, which is obtained by reacting a dimer diamine with a tetracarboxylic dianhydride, to be reacted with maleic anhydride, is also preferable as the radically polymerizable compound (C) because the dielectric loss tangent of the cured product is low.

Specific examples of the bismaleimide compound include MIZ-001 (manufactured by Nippon Kayaku Co., Ltd.).

The content of the radically polymerizable compound (C) in the curable composition may be 10 parts by mass or more and 80 parts by mass or less, or 20 parts by mass or more and 50 parts by mass or less, with respect to 100 parts by mass of the resin.

### [Radical Polymerization Initiator (D)]

As described above, the curable composition includes a radically polymerizable compound (C). Therefore, the curable composition may include a radical polymerization initiator (D) for the purpose of promoting the reaction between the radically polymerizable compounds (C) and reaction between the modified polyphenylene ether (B) and the radically polymerizable compound (C). As the radical polymerization initiator (D), a conventionally known radical polymerization initiator can be used without any particular limitation.

Specific examples are the same as the specific examples of the radical polymerization initiator that can be used when the styrene-based elastomer is graft-modified, and can be used alone or in a mixture of two or more kinds.

The amount of the radical polymerization initiator (D) used is not particularly limited as long as the curable composition is capable of radical polymerization by heating or exposure to light. The amount of the radical polymerization initiator (D) used may be, for example, 1 part by mass or more and 10 parts by mass or less, 1.5 parts by mass or more and 9 parts by mass or less, or 2 parts by mass or more and 8 parts by mass or less, with respect to 100 parts by mass of the radically polymerizable compound (C).

### [Inorganic Filler]

In the curable composition, an inorganic filler can be blended as necessary. Examples of the inorganic filler include calcium carbonate, talc, clay, silica, magnesium carbonate, barium sulfate, titanium oxide, alumina, montmorillonite, gypsum, glass flakes, glass fiber, milled glass fiber, carbon fiber, alumina fiber, silica alumina fiber, aluminum borate whisker, potassium titanate fiber, and the like. The inorganic fillers may be used alone or in combination of two or more kinds.

The amount of these inorganic fillers used is not particularly limited as long as the desired effects are not impaired. The amount of the inorganic fillers used may be 10 parts by mass or more and 200 parts by mass or less, or 20 parts by mass or more and 100 parts by mass or less, with respect to 100 parts by mass of the modified polyphenylene ether (B).

### [Other Additives]

The curable composition may include various additives, which may be included in the above-described modifier (A), as necessary. These additives may be used alone or in combination of two or more kinds.

### [Method for Producing Curable Composition]

The method for producing the curable composition is not particularly limited as long as the method can uniformly mix the modifier (A), the modified polyphenylene ether (B), and the radically polymerizable compound (C). Since the modifier (A), the modified polyphenylene ether (B), and the radically polymerizable compound (C) can be uniformly mixed while avoiding curing by heating, it is preferable to mix the modifier (A), the modified polyphenylene ether (B), and the radically polymerizable compound (C) in the above-mentioned organic solvent to prepare the curable composition.

As the method for producing the curable composition, a method of mixing the modifier (A) including an organic solvent with an organic solvent solution of the modified polyphenylene ether (B) and the radically polymerizable compound (C) is preferable.

Such a method may be a method including obtaining a first stock solution (a) including a modifier (A) and a modified polyphenylene ether (B),
obtaining a second stock solution (b) including a radically polymerizable compound (C), and
mixing the first stock solution (a) and the second stock solution (b).

The first stock solution (a) and the second stock solution (b) usually include an organic solvent. Suitable examples of the organic solvent which the first stock solution (a) and the second stock solution (b) may include are the same as the suitable examples of organic solvent which the modifier (A) may include.

When the curable composition includes a radical polymerization initiator (D), the radical polymerization initiator (D) may be included in any of the first stock solution (a) and the second stock solution (b). However, in terms of the stability of the radically polymerizable compound (C), the radical polymerization initiator (D) may be added to a mixed liquid obtained by mixing the first stock solution (a) and the second stock solution (b). The radical polymerization initiator (D) can be added as a solution, a slurry, or a solid, to the mixed liquid obtained by mixing the first stock solution (a) and the second stock solution (b).

By applying energy to the above-described curable composition by a method such as heating or exposure to light, the curable composition is cured to form a cured product.

The dielectric loss tangent of the cured product measured under condition of 28 to 40 GHz may be less than 0.0050. In particular, the dielectric loss tangent of the cured product measured under condition of 40 GHz may be less than 0.0050. A cured product exhibiting such a dielectric loss tangent is suitable as a material for semiconductor package substrates for smartphones.

As described above, the cured product of the curable composition is suitably used as a material for wiring boards.

Specifically, a metal-clad laminate including a substrate that includes the cured product of the curable composition and including a metal layer serving as a wiring material may be used.

In a wiring board including a substrate including the cured product of the curable composition and a metal layer as a wiring material, the substrate well adheres to the metal layer made of a metal foil such as a copper foil.

In particular, when the metal layer is in contact with the cured product of the curable composition, the metal layer adheres to the substrate particularly well.

When the metal layer is in contact with the cured product of the curable composition, the above-mentioned metal-clad laminate may have a peel strength measured by peeling the metal layer according to, for example, JIS C6471-1995, of 4.0 N/cm or more, 4.5 N/cm or more, or 5.0 N/cm or more.

As mentioned above, the metal layer adheres well to the cured product of the curable composition in the substrate.

For this reason, the main surface of the metal layer may have a low degree of roughness.

In the metal-clad laminate, when the metal layer is in contact with the cured product of the curable composition, the Rz on the main surface side of the metal layer may be 2.5 μm or less, 1.0 μm or less, or 0.5 μm or less, in a state before the metal layer is laminated on the substrate. The lower limit of Rz is not particularly limited, but may be, for example, 0.1 μm or more, or 0.3 μm or more.

A material for the substrate may be a sheet made of a curable composition or a cured product of the curable composition, or a prepreg made of a fiber sheet and a cured product of the curable composition composited with the fiber sheet.

The method for forming a sheet made of the curable composition is not particularly limited. When the curable composition is a varnish-like composition, the sheet made of the curable composition can be formed by a solution casting method. Furthermore, the sheet made of the curable composition is cured to obtain a sheet made of a cured product of the curable composition.

The sheet thus obtained is suitably used as at least one layer constituting a laminated body.

Furthermore, the prepreg can be formed by impregnating a fiber sheet such as a glass fiber sheet with a radically polymerizable curable composition, and then curing the curable composition impregnated into the fiber sheet by a method such as heating or exposure to light.

### EXAMPLES

One or more embodiments of the present invention will be described in more detail below with reference to Examples, but the present invention is not limited to these Examples.

### Production Example 1

### (Production of Modified Styrene-Based Elastomer A1-1)

To a twin-screw extruder (46 mmφ, L/D=63, KTX46, manufactured by Kobe Steel, Ltd.) set at a cylinder temperature of 230° C. and a screw rotation speed of 150 rpm, 100 parts by mass of styrene/ethylenebutylene/styrene elastomer (SEPTON 8007L, manufactured by Kuraray) and 0.15 parts by mass of 1,3-di(tert-butylperoxyisopropyl)benzene (Perbutyl P, manufactured by NOF Corp.) were fed from a hopper port and melt-kneaded. During this time, 1 part by mass of styrene and 1 part by mass of glycidyl methacrylate were added midway through the cylinder. Thereafter, pellets of modified styrene-based elastomer A1-1 were obtained by vacuum devolatilization from a vent port.

The obtained resin pellets were dissolved in xylene at 130° C., and then cooled to room temperature again to precipitate a recrystallized resin. The recrystallized resin was used to measure the content of the epoxy group by an automatic potentiometric titrator (AT700 manufactured by Kyoto Electronics Manufacturing Co., Ltd.) according to JIS K7236.

The content of the epoxy group in the modified styrene-based elastomer A1-1 was 0.21% by mass.

### Production Example 2

### (Production of Modified Styrene-Based Elastomer A1-2)

A modified styrene-based elastomer A1-2 was obtained in the same manner as in Production Example A1, except that SEPTON 8007L was replaced with a styrene/isobutylene/styrene elastomer (SIBSTAR 103T, manufactured by Kaneka Corporation). The content of the epoxy group in the modified styrene-based elastomer A1-2 was 0.34% by mass.

### Production Example 3

Into a 100 L pressure-resistant polymerization vessel, 200 parts by mass of water, 0.03 parts by mass of tripotassium phosphate, 0.25 parts by mass of potassium dihydrogen phosphate, 0.002 parts by mass of ethylenediaminetetraacetic acid (EDTA), 0.001 parts by mass of ferrous sulfate heptahydrate, and 1.5 parts by mass of sodium dodecylbenzenesulfonate (SDBS) were added.

While the mixture in the pressure-resistant polymerization vessel was stirred, oxygen in the pressure-resistant polymerization vessel was sufficiently removed by nitrogen replacement. Then, 75 parts by mass of butadiene (Bd) and 25 parts by mass of styrene were added to the pressure-resistant polymerization vessel. Next, the temperature in the pressure-resistant polymerization vessel was raised to 45° C. Then, 0.015 parts by mass of paramenthane hydroperoxide (PHP) was added to the pressure-resistant polymerization vessel. Next, 0.04 parts by mass of sodium formaldehyde sulfoxylate (SFS) were added to the pressure-resistant polymerization vessel to initiate polymerization.

After 4 hours elapsed from the start of polymerization, 0.01 parts by mass of PHP, 0.0015 parts by mass of EDTA, and 0.001 parts by mass of ferrous sulfate heptahydrate were added to the pressure-resistant polymerization vessel. After 10 hours elapsed from the start of polymerization, the reaction liquid in the pressure-resistant polymerization vessel was depressurized to remove volatile matters such as remaining monomers, and the polymerization was ended. In this manner, a styrene-butadiene rubber latex was obtained.

The volume average particle diameter of the styrene-butadiene rubber particles included in the obtained styrene-butadiene rubber latex was 100 nm.

Into a glass reaction vessel equipped with a thermometer, a stirrer, a reflux condenser, a nitrogen inlet, and a monomer addition device, 241 parts by mass of the obtained styrene-butadiene rubber latex (80 parts by mass of the styrene-butadiene rubber particles) and 65 parts by mass of water were added.

The gas in the glass reaction vessel was replaced with nitrogen. Next, the contents of the glass reaction vessel were stirred at 60° C. Then, 0.004 parts by mass of EDTA, 0.001 parts by mass of ferrous sulfate heptahydrate, and 0.2 parts by mass of SFS were added to the glass reaction vessel. Next, 2 parts by mass of triallyl isocyanurate (TAIC) and 0.07 parts by mass of cumene hydroperoxide (CHP) were added to the glass reaction vessel. Then, the contents of the glass reaction vessel were stirred for 60 minutes. Then, a mixture of 12 parts by mass of styrene, 4 parts by mass of acrylonitrile, 4 parts by mass of glycidyl methacrylate, and 0.08 parts by mass of tert-butyl hydroperoxide (TBP) was continuously added to the glass reaction vessel over 110 minutes.

Thereafter, 0.04 parts by mass of TBP was added to the glass reaction vessel, and the mixture was stirred for another hour to complete the polymerization. Thus, an aqueous latex including the core-shell polymer particles B1 was obtained.

The core-shell polymer particles B1 included in the aqueous latex had a volume average particle diameter of 110 nm. Furthermore, the ratio of the mass of the epoxy group to the mass of the core-shell polymer particles B1 was 1.2% by mass.

Using the obtained aqueous latex, a dispersion liquid of core-shell polymer A2-1 was obtained in which core-shell polymer particles B1 were dispersed in methyl ethyl ketone (MEK) at a solid concentration of 25% by mass according to the method described in Production Example 1 of WO 2020/027189.

### Production Example 4

Into 28.8 g of toluene, 7.2 g of the modified styrene-based elastomer A1-1 obtained in Production Example A1 was dissolved. Next, 11.2 g of a methyl ethyl ketone (MEK) dispersion liquid of the core-shell polymer particles A2-1 (solid concentration: 25% by mass) was added to the toluene solution of the modified styrene-based elastomer A1-1 to obtain 47.2 g of the modifier 1.

The obtained 47.2 g of the modifier 1 includes 2.8 g of the core-shell polymer particles A2-1.

### Production Example 5

A modifier 2 was obtained in the same manner as in Production Example 4, except that the amount of the modified styrene-based elastomer A1-1 was changed from 7.2 g to 7.0 g, and the amount of core-shell polymer particles A2-1 was changed from 2.8 g to 5.4 g.

### Production Example 6

A modifier 3 was obtained in the same manner as in Production Example 4, except that 7.2 g of the modified styrene-based elastomer A1-1 was replaced with 7.2 g of the modified styrene-based elastomer A1-2.

### Production Example 7

A modifier 4 was obtained in the same manner as in Production Example 5, except that 7.0 g of the modified styrene-based elastomer A1-1 was changed to 7.0 g of the modified styrene-based elastomer A1-2.

### Production Example 8

A modifier 5 was obtained in the same manner as in Production Example 4, except that the amount of the modified styrene-based elastomer A1-1 was changed from 7.2 g to 3.0 g.

### Production Example 9

A modifier 6 was obtained in the same manner as in Production Example 4, except that the amount of the modified styrene-based elastomer A1-1 was changed from 7.2 g to 18.0 g, and the amount of toluene was changed from 28.8 g to 48.0 g.

### Production Example 10

A modifier 7 was obtained in the same manner as in Production Example 4, except that the amount of the core-shell polymer particles A2-1 was changed from 2.8 g to 0.15 g.

### Production Example 11

A modifier 8 was obtained in the same manner as in Production Example 4, except that the amount of the core-shell polymer particles A2-1 was changed from 2.8 g to 9.0 g and that the amount of toluene was changed from 28.8 g to 35.0 g.

In the comparative examples, the following A1-3, A1-4, and A1-5 were used as other elastomers (A′1).

A1-3: Unmodified styrene-based elastomer (styrene/ethylene-butylene/styrene elastomer, SEPTON 8007L manufactured by Kuraray)
A1-4: Polyolefin-based elastomer including 4-methyl-1-pentene units (ABSORTOMER (registered trademark) EP-1013, manufactured by Mitsui Chemicals)
A1-5: Unmodified styrene-based elastomer (hydrogenated styrene-butadiene block copolymer, DYNARON (registered trademark) 8903P manufactured by JSR Corporation)

In Examples, the following B1 to B3 were used as the modified polyphenylene ethers (B).

B1: Modified polyphenylene ether with both terminals modified with methacrylate (Noryl (registered trademark) SA9000, manufactured by SABIC, number average molecular weight: 1700, carbon-carbon unsaturated double bond equivalent amount: 850 g/eq)
B2: Modified polyphenylene ether with both terminals modified with a vinylbenzyl group (OPE-2St-2200 manufactured by Mitsubishi Gas Chemical Company, Inc., number average molecular weight: 2070, carbon-carbon unsaturated double bond equivalent: 1090 g/eq)
B3: Modified polyphenylene ether with both terminals modified with vinylbenzyl groups (OPE-2St-1200 manufactured by Mitsubishi Gas Chemical Company, Inc., number average molecular weight: 1100, carbon-carbon unsaturated double bond equivalent: 660 g/eq)

In Comparative Examples, the following B4 was used as the unmodified polyphenylene ether (B′).

B4: Unmodified polyphenylene ether including hydroxyl groups at both terminals (Noryl (registered trademark) SA90, manufactured by SABIC)

In Examples and Comparative Examples, the following C1 to C3 were used as the radically polymerizable compound (C). The followings were used as silica and the radical polymerization initiator (D).

C1: Triallyl isocyanurate (TAIC, manufactured by Mitsubishi Chemical Corporation)
C2: Divinylbenzene (mixture of meta and para isomers, manufactured by Tokyo Chemical Industry Co., Ltd.)
C3: Bismaleimide compound (MIZ-001 manufactured by Nippon Kayaku Co., Ltd.)
Silica: SC2300-SVJ (manufactured by Admatechs, average particle diameter: 0.5 μm)
Radical polymerization initiator (D): Perbutyl P (PBP) (manufactured by NOF Corporation)

### Examples 1 to 14

In Examples 1, 5 to 8, 13, and 14, the modifier 1 was used.

In Example 2, the modifier 2 was used.

In Example 3, the modifier 3 was used.

In Example 4, the modifier 4 was used.

In Example 9, the modifier 5 was used.

In Example 10, the modifier 6 was used.

In Example 11, the modifier 7 was used.

In Example 12, the modifier 8 was used.

The modified polyphenylene ether (B) of the amount and type shown in Table 1, the radically polymerizable compound (C) of the amount and type shown in Table 1, silica of the amount of shown in Table 1, and 1.1 g of the radical polymerization initiator (D) were dissolved and dispersed in toluene of the amount shown in Table 1 to obtain a toluene dispersion liquid. The above-mentioned modifier was added to the toluene dispersion liquid and stirred uniformly to obtain a curable composition of each Example.

Note here that in Examples 5 to 8, the radical polymerization initiator (D) was not used.

### Comparative Example 1

The modified polyphenylene ether (B) of the amount and type shown in Table 2, the silica of the amount shown in Table 2, and 2.5 g of the radical polymerization initiator (D) were dissolved and dispersed in the toluene of the amount shown in Table 2 to obtain a curable composition.

### Comparative Example 2

The modified polyphenylene ether (B) of the amount and type shown in Table 2, silica of the amount shown in Table 2, and 1.1 g of the radical polymerization initiator (D) were dissolved and dispersed in toluene of the amount shown in Table 2 to obtain a toluene dispersion liquid. The modifier 1 was added to the toluene dispersion liquid and stirred uniformly to obtain a curable composition.

### Comparative Example 3

In toluene of the amount shown in Table 2, 70.0 g of unmodified polyphenylene ether having hydroxyl groups at both terminals (Noryl (registered trademark) SA90, manufactured by SABIC Corporation), the radically polymerizable compound (C) of the amount and type shown in Table 2, silica of the amount shown in Table 2, and 2.5 g of the radical polymerization initiator (D) were dissolved and dispersed to obtain a curable composition.

### Comparative Example 4

Unmodified polyphenylene ether (B′) of the amount and type shown in Table 2, the radically polymerizable compound (C) of the amount and type shown in Table 2, silica of the amount shown in Table 2, and 1.1 g of the radical polymerization initiator (D) were dissolved and dispersed in toluene of the amount shown in Table 2 to obtain a toluene dispersion liquid. The above-mentioned modifier 1 was added to the toluene dispersion liquid and stirred uniformly to obtain a curable composition.

### Comparative Example 5

The modified polyphenylene ether (B) of the amount and type shown in Table 2, the radically polymerizable compound (C) of the amount and type shown in Table 2, silica of the amount shown in Table 2, and 1.1 g of the radical polymerization initiator (D) were dissolved and dispersed in the toluene of the amount shown in Table 2 to obtain a curable composition.

### Comparative Example 6

A modifier (A′) not corresponding to the modifier (A) was obtained in the same manner as in Production Example 4 except that 7.2 g of the modified styrene-based elastomer A1-1 was replaced with another elastomer (A′1) of the amount and type shown in Table 2.

The modified polyphenylene ether (B) of the amount and type shown in Table 2, the radically polymerizable compound (C) of the amount and type shown in Table 2, silica of the amount shown in Table 2, and 1.1 g of the radical polymerization initiator (D) were dissolved and dispersed in toluene of the amount shown in Table 2 to obtain a toluene dispersion liquid. The above-mentioned modifier (A′) was added to the toluene dispersion liquid and stirred uniformly to obtain a curable composition.

### Comparative Example 7

A modifier (A′) not corresponding to the modifier (A) was obtained in the same manner as in Production Example 4 except that 7.2 g of the modified styrene-based elastomer A1-1 was replaced with another elastomer (A′1) of the amount and type shown in Table 2, and the amount of 2.8 g of core-shell polymer particles B1 was changed from 2.8 g to 2.6 g.

The modified polyphenylene ether (B) of the amount and type shown in Table 2, the radically polymerizable compound (C) of the amount and type shown in Table 2, silica of the amount shown in Table 2, and 1.1 g of the radical polymerization initiator (D) were dissolved and dispersed in toluene of the amount shown in Table 2 to obtain a toluene dispersion liquid. The above-mentioned modifier (A′) was added to the toluene dispersion liquid and stirred uniformly to obtain a curable composition.

### Comparative Example 8

Into toluene of the amount shown in Table 2, 12.0 g of a methyl ethyl ketone (MEK) dispersion liquid of the core-shell polymer particles A2-1 (solid concentration: 25% by mass) including 3.0 g of the core-shell polymer particles A2-1, the modified polyphenylene ether (B) of the amount and type shown in Table 2, the radically polymerizable compound (C) of the amount and type shown in Table 2, silica of the amount shown in Table 2, and 1.2 g of the radical polymerization initiator (D) were dissolved and dispersed to obtain a curable composition.

### Comparative Example 9

The modified styrene-based elastomer (A) of the amount and type shown in Table 2, the modified polyphenylene ether (B) of the amount and type shown in Table 2, the radically polymerizable compound (C) of the amount and type shown in Table 2, silica of the amount shown in Table 2, and 1.1 g of the radical polymerization initiator (D) were dissolved and dispersed in toluene of the amount shown in Table 2 to obtain a curable composition.

### Comparative Example 10

The modified polyphenylene ether (B) of the amount and type shown in Table 2, the radically polymerizable compound (C) of the amount and type shown in Table 2, silica of the amount shown in Table 2, and 2.5 g of the radical polymerization initiator (D) were dissolved and dispersed in toluene of the amount shown in Table 2 to obtain a curable composition.

Using the curable composition obtained in each of Examples and Comparative Examples, prepregs were obtained according to the following method.

Specifically, glass cloth (manufactured by Nitto Boseki Co., Ltd., product name: NE-1078, size: 100 mm×200 mm) was impregnated with the curable composition.

The glass cloth impregnated with the curable composition was allowed to pass between two Teflon rods arranged in parallel with a gap of 0.4 mm between the rods to remove excess curable composition. The glass cloth impregnated with the curable composition was heated at 60° C. for 100 minutes, at 100° C. for 10 minutes, and at 120° C. for 50 minutes in this order to obtain a prepreg.

Using the obtained prepreg, the adhesion of an electrolytic copper foil was evaluated, the dielectric loss tangent was measured, and the heat resistance was evaluated according to the following methods.

### [Measurement of Dielectric Loss Tangent (Df)]

A cured sheet was formed using the prepreg obtained using the curable composition of each of Examples and Comparative Examples. The dielectric loss tangent was measured using a test piece cut out from the cured sheet. The specific method is described below. The measurement results of the dielectric loss tangent are shown in Tables 1 and 2.

### <Preparation of Cured Sheet>

Using the prepregs obtained in each of Examples and Comparative Examples, cured sheets were produced according to the following method.

Firstly, the prepreg was sandwiched between two Teflon sheets (manufactured by Nitto Denko Corporation, product name: Nitoflon (registered trademark), thickness 50 μm). The prepreg sandwiched between the two Teflon sheets was set in a press machine at a press temperature of 100° C. and a press pressure of 0.5 MPa (G), and then the press temperature was increased at a rate of 3° C./min. When the press temperature reached 140° C., the press pressure was increased to 3.0 MPa (G). Next, the press temperature was increased to 200° C. at a rate of 3° C./min. After the press temperature reached 200° C., pressing was continued for 75 minutes to obtain a cured sheet in which the cured product of the curable composition and the glass sheet were combined.

### <Measurement of Dielectric Loss Tangent>

The dielectric loss tangent was measured using a network analyzer (N5222B manufactured by KEYSIGHT) and a split cylinder resonator (CR-740 manufactured by EM Labs) as measuring devices. A 30 mm×40 mm test piece cut out from the cured sheet was used for measuring the dielectric loss tangent. The test piece was left to stand for 24 hours under conditions of 23° C. and 50% R.H. before measuring of the dielectric loss tangent. The measurement conditions were as follows:

Measurement frequency: 40 GHz

### Temperature: 23° C.

### Humidity: 50% R.H.

### [Evaluation of Adhesion of Electrolytic Copper Foil]

The prepreg obtained using the curable composition of each Example and Comparative Example was used. A metal laminated body was formed by laminating an electrolytic copper foil on both sides of the cured sheet of the cured prepreg. The peel strength of the metal foil was measured using the obtained metal laminated body.

The specific method will be described below. The peel strength measurement results are shown in Tables 1 and 2.

### <Preparation of Metal Laminated Body>

Using the prepreg obtained in each of Examples and Comparative Examples, metal laminated bodies were produced according to the following method.

Firstly, the prepreg was sandwiched between two identical electrolytic copper foils on the laminate surface (matte surface) side. The prepreg sandwiched between the two electrolytic copper foils was set in a press machine at a press temperature of 100° C. and a press pressure of 0.5 MPa (G), and then the press temperature was increased at a rate of 3° C./min. When the press temperature reached 140° C., the press pressure was increased to 3.0 MPa (G). Next, the press temperature was increased to 200° C. at a rate of 3° C./min. After the press temperature reached 200° C., pressing was continued for 75 minutes to obtain a metal laminated body. In the metal laminated body, electrolytic copper foils were laminated on both main surfaces of the cured sheet in which the cured product of the curable composition and the glass sheet were combined.

Note here that the following three types of copper foils were used.

Copper foil 1: An electrolytic copper foil manufactured by Mitsui Mining & Smelting Co., Ltd., product name: HS1-VSP, thickness: 18 μm, laminate surface roughness Rz: 1.52 μm, Ra: 0.24 μm
Copper foil 2: An electrolytic copper foil manufactured by Mitsui Mining & Smelting Co., Ltd., product name: SI-VSP, thickness: 18 μm, laminate surface roughness Rz: 0.56 μm, Ra: 0.07 μm
Copper foil 3: An electrolytic copper foil manufactured by Fukuda Metal Foil & Powder Co., Ltd., product name: CF-T49A-DS-HD2-18, thickness: 18 μm, laminate surface roughness Rz: 0.42 μm, Ra: 0.06 μm

### <Measurement of Rz and Ra of Copper Foil Laminate Surface>

The Rz and Ra of a copper foil laminate surface were measured as follows using a scanning probe microscope manufactured by Bruker AXS (device name: Dimension Icon) as the measuring device.

Measurement mode: Tapping
Measurement range: 50 μm×50 μm
Number of data: 512×512

### Probe: HQ: NSC15/AI BS

The resulting metal laminated body was used to measure the peel strength of the electrolytic copper foil according to JIS C6471-1995 “6.5 Peel Strength”. Specifically, a 1-mm wide metal foil portion was peeled off under conditions of a peel angle of 90° and a peel speed of 100 mm/min. The load applied during peeling was measured, and the measured load was taken as the peel strength. The measured peel strength values are shown in Tables 1 and 2.

### [Heat Resistance Evaluation]

A test piece of 50 mm×50 mm was cut out from the metal laminated body prepared according to the method for preparing the metal laminated body. The test piece was placed in a hot air oven under conditions of 260° C. for 1 hour. The test piece heated in the oven was visually checked for appearance defects such as expansion or peeling of the metal laminated body. The test piece was left to stand for 24 hours under conditions of 23° C. and 50% R.H. before the heat resistance test.

⊙: No change in appearance such as expansion or peeling of the metal laminated body was observed.

o: Expansion was observed in one location in the metal laminated body

x: Expansion or peeling was observed in two or more locations in the metal laminated body.

In Table 1 below, the (A1) component is a modified styrene-based elastomer (A1-1). The (A2) component is a core-shell polymer particle (A2). The (B) component is a modified polyphenylene ether. The (C) component is a radically polymerizable compound (C). The (D) component is a radical polymerization initiator (D).

TABLE 1

| | | | | | | | | | Peel | | |
|---|---|---|---|---|---|---|---|---|---|---|---|
| | | | | | | | | | strength of | | |
| | | | | | | | | | copper foil | | |
| | | | | | | | | | (N/cm) | | |
| | | | | | | | | | Copper | | |
| | Curable composition | | | | | | | | foil 1/ | Electrical | |
| | Modifier (A) | | | | | | | | Copper | property | Heat |
| | (A1) | (A2) | | | (B) | (C) | | (D) | foil 2/ | (Df) | resistance |
| | component | component | Toluene | Toluene | component | component | Silica | component | Copper | [symbol] | at |
| | Type/(g) | Type/(g) | (g) | (g) | Type/(g) | Type/(g) | (g) | (g) | foil 3 | Hz | 260° C. |
| Example 1 | A1-1/ | A2-1/ | 28.8 | 90.0 | B1/ | C1/ | 27.5 | 1.1 | 6.8/ | 3.9 × 10 [symbol] | ⊚ |
| | 7.2 | 2.8 | | | 43.0 | 18.4 | | | 6.2 | | |
| | | | | | | | | | 4.6 | | |
| Example 2 | A1-1/ | A2-1/ | 28.8 | 87.7 | B1/ | C1/ | 26.8 | 1.1 | 6.5/ | 4.1 × 10 [symbol] | ⊚ |
| | 7.0 | 5.4 | | | [symbol] | 17.9 | | | 6.3/ | | |
| | | | | | | | | | 5.0 | | |
| Example 3 | A1-2/ | A2-1/ | 28.8 | [symbol] | B1/ | C1/ | 27.5 | 1.1 | 5.1/ | 4.1 × 10 [symbol] | ⊚ |
| | 7.2 | 2.8 | | | 43.0 | 18.4 | | | 5.3/ | | |
| | | | | | | | | | 4.4 | | |
| Example 4 | A1-2/ | A2-1/ | 28.8 | 87.7 | B1/ | C1/ | 26.8 | 1.1 | 5.7/ | 3.9 × 10 [symbol] | ⊚ |
| | 7.0 | 5.4 | | | 41.9 | 17.9 | | | 5.8/ | | |
| | | | | | | | | | 4.2 | | |
| Example 5 | A1-1/ | A2-1/ | 28.8 | 90.0 | B2/ | C1/ | 27.5 | — | 7.9/ | 2.7 × 10 [symbol] | ⊚ |
| | 7.2 | 2.8 | | | 43.0 | 18.4 | | | [symbol] / | | |
| | | | | | | | | | 6.9 | | |
| Example 6 | A1-1/ | A2-1/ | 28.8 | 90.0 | B2/ | C2/ | 27.5 | — | 7.7/ | 2.5 × 10 [symbol] | ⊚ |
| | 7.2 | 2.8 | | | 43.0 | 18.4 | | | 7.5/ | | |
| | | | | | | | | | 7.2 | | |
| Example 7 | A1-1/ | A2-1 | 28.8 | 90.0 | B2/ | C3/ | 27.5 | — | 6.8/ | 2.3 × 10 [symbol] | ⊚ |
| | 7.2 | 2.8 | | | 43.0 | 18.4 | | | 5.6/ | | |
| | | | | | | | | | 4.8 | | |
| Example 8 | A1-1/ | A2-1/ | 28.8 | 90.0 | [symbol] / | C1/ | 27.5 | — | 6.0/ | 3.0 × 10 [symbol] | ⊚ |
| | 7.2 | 2.8 | | | 43.0 | 18.4 | | | 5.9/ | | |
| | | | | | | | | | 5.1 | | |
| Example 9 | A1-1/ | A2-1/ | 28.8 | 90.0 | B1/ | C1/ | 27.5 | 1.1 | 6.7/ | 4.3 × 10 [symbol] | ⊚ |
| | 3.0 | 2.8 | | | 43.0 | 18.4 | | | 6.3/ | | |
| | | | | | | | | | 4.1 | | |
| Example 10 | A1-1/ | A2-1/ | 48.0 | 90.0 | B1/ | C1/ | 27.5 | 1.1 | 7.2/ | 3.7 × 10 [symbol] | ⊚ |
| | 18.0 | 2.8 | | | 43.0 | 18.4 | | | 6.6/ | | |
| | | | | | | | | | 4.5 | | |
| Example 11 | A1-1/ | A2-1/ | 28.8 | 90.0 | B1/ | C1/ | 27.5 | 1.1 | 6.5/ | 4.2 × 10 [symbol] | ⊚ |
| | 7.2 | 0.15 | | | 43.0 | 18.4 | | | 5.8/ | | |
| | | | | | | | | | 4.1 | | |
| Example 12 | A1-1/ | A2-1/ | 35.0 | 90.0 | B1/ | C1/ | 27.5 | 1.1 | 6.0/ | 4.3 × 10 [symbol] | ⊚ |
| | 7.2 | 9.0 | | | 43.0 | [symbol] | | | [symbol] / | | |
| | | | | | | | | | 4.5 | | |
| Example 13 | A1-1/ | A2-1/ | 28.5 | 78.0 | B1/ | C1/ | 27.5 | 1.1 | 6.5/ | 4.1 × 10 [symbol] | ◯ |
| | 7.2 | 2.8 | | | 43.0 | 7.0 | | | 6.5/ | | |
| | | | | | | | | | 6.0 | | |
| Example 14 | A1-1/ | A2-1/ | 28.8 | 100.0 | B1/ | C1/ | 27.5 | 1.1 | 6.9/ | [symbol] × 10 [symbol] | ⊚ |
| | 7.2 | 2.8 | | | 43.0 | 28.0 | | | 6.7/ | | |
| | | | | | | | | | 6.6 | | |

[symbol]

indicates data missing or illegible when filed

In Table 2 below, the (A1) component is a modified styrene-based elastomer (A1-1). The (A′1) component is an elastomer (A′1) other than a modified styrene-based elastomer. The (A2) component is a core-shell polymer particle (A2). The (B) component is a modified polyphenylene ether. The (B′) component is an unmodified polyphenylene ether (B′). The (C) component is a radically polymerizable compound (C). The (D) component is a radical polymerization initiator (D).

TABLE 2

| | | | | | | | | | Peel | | |
|---|---|---|---|---|---|---|---|---|---|---|---|
| | | | | | | | | | strength | | |
| | | | | | | | | | of | | |
| | | | | | | | | | copper | | |
| | | | | | | | | | foil | | |
| | Curable composition | | | | | | | | (N/cm) | | |
| | Modifier (A) of modifier (A′) | | | | | | | | Copper | | |
| | (A1) | | | | (B) | | | | foil 1/ | Electrical | |
| | component | | | | Component | | | | Copper | property | Heat |
| | or (A′1) | (A2) | | | or (B′) | (C) | | (D) | foil 2/ | (Df) | resistance |
| | component | component | Toluene | Toluene | component | component | Silica | component | Copper | [symbol] | at |
| | Type/(g) | Type/(g) | (g) | (g) | Type/(g) | Type/(g) | (g) | (g) | foil 3 | Hz | 260° C. |
| Comparative | — | — | — | 180.0 | B1/ | — | 60.0 | 2.5 | 2.5/ | 5.0 × 10 [symbol] | X |
| Example 1 | | | | | 100.0 | | | | 2.0/ | | |
| | | | | | | | | | 2.0 | | |
| Comparative | A1-1/ | A2-1/ | 28.8 | 70.0 | B1/ | — | 27.5 | 1.1 | 2.4/ | 3.9 × 10 [symbol] | X |
| Example 2 | 7.2 | 2.8 | | | 43.0 | | | | 1.8/ | | |
| | | | | | | | | | 3.6 | | |
| Comparative | — | — | — | 180.0 | B4/ | C1/ | 60.0 | 2.5 | 1.2/ | 9.0 × 10 [symbol] | X |
| Example 3 | | | | | 70.0 | 30.0 | | | 2.2/ | | |
| | | | | | | | | | 2.0 | | |
| Comparative | A1-1/ | A2-1/ | 28.8 | 90.0 | B4/ | C1/ | 27.5 | 1.1 | 0.4/ | 6.2 × 10 [symbol] | X |
| Example 4 | 7.2 | 2.8 | | | 43.0 | 18.4 | | | 0.5/ | | |
| | | | | | | | | | 0.6 | | |
| Comparative | — | — | — | 100.0 | B1/ | C1/ | 26.2 | 1.1 | 1.3/ | 4.4 × 10 [symbol] | ⊚ |
| Example 5 | | | | | 55.2 | 17.6 | | | 2.0/ | | |
| | | | | | | | | | 2.3 | | |
| Comparative | A1-3/ | A2-1/ | 28.8 | 90.0 | B1/ | C1/ | 27.5 | 1.1 | 6.0/ | 4.3 × 10 [symbol] | X |
| Example 6 | 7.2 | 2.8 | | | 43.0 | 18.4 | | | 5.5/ | | |
| | | | | | | | | | 3.9 | | |
| Comparative | A1-4/ | A2-1/ | 28.8 | 90.0 | B1/ | C1/ | 26.2 | 1.1 | 2.7/ | 3.9 × 10 [symbol] | X |
| Example 7 | 6.8 | 2.6 | | | 41.0 | 27.6 | | | 2.3/ | | |
| | [symbol] | | | | | | | | 5.2 | | |
| | 4.8 | | | | | | | | | | |
| Comparative | — | A2-1/ | — | 106.0 | B1/ | C1/ | 29.6 | 1.2 | 2.9/ | 4.4 × 10 [symbol] | ⊚ |
| Example 8 | | 3.0 | | | 46.3 | 19.9 | | | 2.3/ | | |
| | | | | | | | | | 3.5 | | |
| Comparative | A1-1/ | — | — | 92.6 | B1/ | C1/ | 28.3 | 1.1 | 1.8/ | 4.6 × 10 [symbol] | ⊚ |
| Example 9 | 7.4 | | | | 44.2 | 19.0 | | | 1.8/ | | |
| | | | | | | | | | 3.5 | | |
| Comparative | — | — | — | 180.0 | B1/ | C1/ | 60.0 | 2.5 | 1.3/ | 4.6 × 10 [symbol] | ⊚ |
| Example 10 | | | | | 70.0 | 30.0 | | | 1.4/ | | |
| | | | | | | | | | 2.9 | | |

[symbol]

indicates data missing or illegible when filed

Table 1 shows that the curable compositions of Examples including the modifier (A) including the modified resin (A1) satisfying the above-described predetermined conditions and the core-shell polymer particles (A2) satisfying the above-described predetermined conditions, the modified polyphenylene ether (B) having a carbon-carbon unsaturated double bond-containing group bonded to an oxygen atom at the molecular chain terminal, and the radically polymerizable compound (C) give cured products having both excellent adhesion to a copper foil and a low dielectric loss tangent.

Furthermore, the cured products of the curable compositions of Examples had excellent heat resistance.

On the other hand, Comparative Examples show that the cured products of the curable compositions lacking at least one of the essential components have poor adhesion to a copper foil or a high dielectric loss tangent.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A curable composition comprising:
a modifier (A);
a modified polyphenylene ether (B); and
a radically polymerizable compound (C),
wherein:
the modifier (A) comprises a modified resin (A1) and core-shell polymer particles (A2),
the modified resin (A1) comprises a modified styrene-based elastomer (A1-1),
the modified resin (A1) and the core-shell polymer particles (A2) are modified with a monomer having one or more polar groups selected from the group consisting of an epoxy group, an amino group, an acid anhydride group, a hydroxy group, and a carboxy group,
a type of a group with a largest amount among the one or more polar groups of the modified resin (A1) is the same as a type of a group with a largest amount among the one or more polar groups of the core-shell polymer particles (A2),
the modified polyphenylene ether (B) comprises a carbon-carbon unsaturated double bond-containing group bonded to an oxygen atom at a molecular chain terminal, and
the radically polymerizable compound (C) comprises two or more radically polymerizable carbon-carbon unsaturated double bonds.

2. The curable composition according to claim 1, wherein the modified polyphenylene ether (B) comprises, as the carbon-carbon unsaturated double bond-containing group, at least one selected from the group consisting of a vinylbenzyl group, a vinyl group, an allyl group, and a (meth)acryloyl group.

3. The curable composition according to claim 1, wherein the group with a largest amount among the one or more polar groups of the modified resin (A1) and the group with a largest amount among the one or more polar groups of the core-shell polymer particles (A2) are an epoxy group.

4. The curable composition according to claim 1, comprising:
25 parts by mass or more and 90 parts by mass or less of the modified resin (A1); and
10 parts by mass or more and 75 parts by mass or less of the core-shell polymer particles (A2),
with respect to 100 parts by mass of the modifier (A).

5. The curable composition according to claim 1, wherein a content of the one or more polar groups in the modified resin (A1) is 0.1% by mass or more and 8% by mass or less with respect to a mass of the modified resin (A1).

6. The curable composition according to claim 1, wherein a content of the one or more polar groups in the core-shell polymer particles (A2) is 0.5% by mass or more and 10% by mass or less with respect to a mass of the core-shell polymer particles (A2).

7. The curable composition according to claim 1, wherein an amount of the radically polymerizable compound (C) is 10 parts by mass or more and 80 parts by mass or less with respect to 100 parts by mass of the modified polyphenylene ether (B).

8. The curable composition according to claim 1, wherein an amount of the core-shell polymer particles (A2) is 0.1 parts by mass or more and 30 parts by mass or less with respect to 100 parts by mass of the modified polyphenylene ether (B).

9. The curable composition according to claim 1, wherein an amount of the modified resin (A1) is 5 parts by mass or more and 50 parts by mass or less with respect to 100 parts by mass of the modified polyphenylene ether (B).

10. A cured product of the curable composition according to claim 1.

11. The cured product according to claim 10, wherein a dielectric loss tangent measured under condition of 40 GHz is less than 0.0050.

12. A metal-clad laminate comprising:
a substrate comprising the cured product according to claim 10; and
a metal layer.

13. The metal-clad laminate according to claim 12, wherein:
the metal layer is in contact with the cured product, and
a peel strength measured by peeling off the metal layer according to JIS C6471-1995 is 4.0 N/cm or more.

14. The metal-clad laminate according to claim 13, wherein Rz on a main surface side of the metal layer is 0.3 μm or more and 2.0 μm or less in a state before the metal layer is laminated on the substrate.

15. A method for producing the curable composition according to claim 1, comprising:
obtaining a first stock solution (a) comprising the modifier (A) and the modified polyphenylene ether (B);
obtaining a second stock solution (b) comprising the radically polymerizable compound (C); and
mixing the first stock solution (a) and the second stock solution (b).
